(19) United States
(12) Patent Application Publication
(10) Pub. No.: US 2012/0038159 A1
(43) Pub. Date: Feb. 16, 2012

(54) WIND POWER GENERATING DEVICE FOR USE WITH A VEHICLE

(76) Inventors: Tzeng-Yuan CHEN, Tamsui (TW); Yean-Der Kuan, Taiping (TW); Yi-Ting Liao, Tamsui (TW)

(21) Appl. No.: 12/856,509

(22) Filed: Aug. 13, 2010

(51) Int. Cl. F03D 9/02; F03D 11/00; H02J 7/32

(52) U.S. Cl. 290/50; 290/55

(57) ABSTRACT

A wind power generating device for use with a vehicle is provided. The wind power generating device is disposed in a front side of an engine chamber of the vehicle and includes: at least one fan blade being driven to rotate by a current of external air introduced into the engine chamber in a manner of natural feeding while the vehicle is moving; a power generator for operating in conjunction with the fan blades and generating electric power; a duct circumferentially disposed at an outermost portion of the fan blades and having an opening, the opening receiving the fan blades, wherein the opening has a front opening portion functioning as a inlet for the external air and a rear opening portion functioning as an outlet for the external air, and the front opening portion being smaller than the rear opening portion.

### FIELD OF THE INVENTION

The present invention relates to wind power generating devices, and more particularly, to a wind power generating device disposed inside an engine chamber of a vehicle.

### BACKGROUND OF THE INVENTION

Taiwan Utility Model Patent No. M345880, entitled “Wind Power Generating Device Using Air Flowing in Opposite Direction to an Advancing Vehicle”, discloses a wind power generating device disposed on top of a vehicle and configured to use air flowing in opposite direction to the vehicle, wherein the device comprises: a vehicle; a horizontal wind power generator and/or a vertical wind power generator; a first driving device composed of a vehicle engine, a clutch, a speed-change device, and a transmission spindle; and a second driving device composed of a horizontal wind power generator rotated by stator duct blades, a vertical wind power generator with an axis rotated and driven by a vane, an energy storing device, an electrical energy indicating device, and a stepless speed-change motor. The device further comprises a tapered gradient board, a first concave slanted tank, a second concave slanted tank, a first supporting rod, a second supporting rod, a first supporting board, a second supporting board, a first connecting rod, and a second connecting rod. The tapered gradient board is transversely fixed to a top portion of the vehicle and positioned before the longitudinal middle line of the vehicle body, and covers the horizontal wind power generator from above and from the front, by means of the first supporting rod, the second supporting rod, the first supporting board, the second supporting board, the first connecting rod, and the second connecting rod. The first concave slanted tank and the second concave slanted tank are fixed to the two sides of the vehicle, respectively, positioned before the longitudinal middle line of the vehicle body, and fixed to the front of the vertical wind power generator. Nonetheless, the prior art is likely to increase the height of the vehicle body, require the reinforcement of the vehicle structure, face with safety-related problems, and increased air resistance.

Taiwan Utility Model Patent No. M355843, entitled “Motor-driven Vehicle Power System with Wind-dependent Double Energy Sources”, discloses a motor-driven vehicle power system with wind-dependent double energy sources, wherein the motor-driven vehicle power system is disposed inside an engine chamber. The motor-driven vehicle power system comprises a wind mechanism and a power supplying mechanism. The wind mechanism and the power supplying mechanism are connected to an electrical energy accessing device via a clutch. The electrical energy accessing device has a power generating module and at least two rechargeable batteries. The motor-driven vehicle power system further comprises a main controller for receiving a wind speed signal generated by a wind speed sensing unit. Under the control of the main controller, the clutch switches and becomes coupled to the power supplying mechanism whenever the wind speed signal level is lower than a predetermined wind speed, such that the power generated by another power source drives the power supplying mechanism so as for the power generating module to generate power and recharge the rechargeable batteries. When the wind speed signal level is higher than the predetermined wind speed, the main controller makes the clutch switch and be coupled to the wind mechanism, so as for the wind mechanism to drive the power generating module for power generation and recharge the rechargeable batteries. The electrical energy accessing device supplies electric power to a displacement transmission device for driving the displacement transmission device. However, the prior art does not disclose a duct.

U.S. Pat. No. 7,018,166B2, titled “Ducted Wind Turbine,” and U.S. Pat. No. 4,075,500, titled “Variable Stator, Diffuser Augmented Wind Turbine Electrical Generation System,” both have disclosed a wind turbine with duct design. However, the disclosed structure design for wind turbines is difficult to be mounted and configured within an engine room of a car.

Furthermore, in published US patent application publication No. 2008/0041643A1, titled “Wind-Power Vehicle (AKV WPV)”, U.S. Pat. No. 6,138,781, titled “System For Generating Electricity In A Vehicle”, U.S. Pat. No. 5,920,127, titled “Propeller Wind Charging System For Electrical Vehicle”, U.S. Pat. No. 7,147,069B2, titled “Wind Turbine Driven Generator System For A Motor Vehicle”, U.S. Pat. No. 6,700,215B2, titled “Multiple Installation Varie Gated Generators For Fossil Fuel-And Electric-Powered Vehicles”, and U.S. Pat. No. 6,897,575B1, titled “Portable Wind Power Apparatus For Electric Vehicles,” the wind power generators disclosed in above-listed US patents are placed and mounted on car top, hood, chassis, or even within the exhaust pipe, respectively, so as to result in a few problems, such as the car body is raised, the car structure needs to be strengthened, safety issues, and also increasing the air resistance of the car. On the other hand, for the wind power generators disclosed in above-listed US patents, because the blades of the wind power generators have no improved design, the electricity power generated by the wind power generators cannot cause substantial benefits for charging of a car.

The inventor of the present invention is concerned about the drawbacks of the prior art and thus engaged in the improvement of the prior art. As a result, the inventor proposes a wind power generating device disposed in an engine chamber of a vehicle and configured to treat incoming air current, which is introduced into the engine chamber of the vehicle in a manner of natural feeding, as a wind source for wind power generation, and a duct for enhancing the rotational efficiency of the fan blades to thereby increase the power generation capacity of a power generator.

### SUMMARY OF THE INVENTION

It is an objective of the present invention to provide a wind power generating device for treating incoming air current, which is introduced into the engine chamber of the vehicle in a manner of natural feeding, as a wind source for wind power generation.

Another objective of the present invention is to provide a wind power generating device that comprises a duct for enhancing the rotational efficiency of the fan blades to thereby increase the power generation capacity of a power generator.

In order to achieve the above and other objectives, the present invention provides a wind power generating device for use with a vehicle, wherein the wind power generating device being disposed in a front side of an engine chamber of the vehicle, comprising: at least one fan blade being driven to rotate by a current of external air introduced into the engine chamber by natural feeding while the vehicle is moving; a power generator for operating in conjunction with the fan blades and generating electric power; and a duct circumferentially disposed at an outermost portion of the fan blades and having an opening, the opening receiving the fan blades, wherein the opening has a front opening portion functioning as an inlet for the external air and a rear opening portion functioning as an outlet for the external air, and the front opening portion being smaller than the rear opening portion.

### BRIEF DESCRIPTION OF THE DRAWINGS

To enable persons skilled in the art to gain insight into the structures, features, and effects of use of the present invention, the present invention is hereunder illustrated with preferred embodiments in conjunction with the accompanying drawings, wherein:

FIG. 1 is a front view of a wind power generating device for use with a vehicle according to the present invention;

FIG. 2 is a perspective view for the assembly of a duct, fan blades, and a power generator of the wind power generating device for use with a vehicle according to the present invention;

FIG. 3 is a schematic view of the wind power generating device disposed in an engine chamber of a vehicle according to the present invention;

FIG. 4A illustrates a structure of a fan blade of the wind power generating device for use with a vehicle in an embodiment according to the present invention;

FIG. 4B is a cross-sectional view of the fan blade shown in FIG. 4A;

FIG. 5A is a cross-sectional view of a duct taken along line B-B of FIG. 2, wherein the duct is configured to be applied to the wind power generating device for use with a vehicle in an embodiment according to the present invention;

FIG. 5B is a cross-sectional view of a protruding portion of the duct shown in FIG. 5A and which is taken along line A-A of FIG. 2;

FIG. 6A is a cross-sectional view of the duct configured to be applied to the wind power generating device for use with a vehicle in another embodiment according to the present invention; and

FIG. 6B is a cross-sectional view of the protruding portion of the duct shown in FIG. 6A.

### DETAILED DESCRIPTION OF THE INVENTIONS

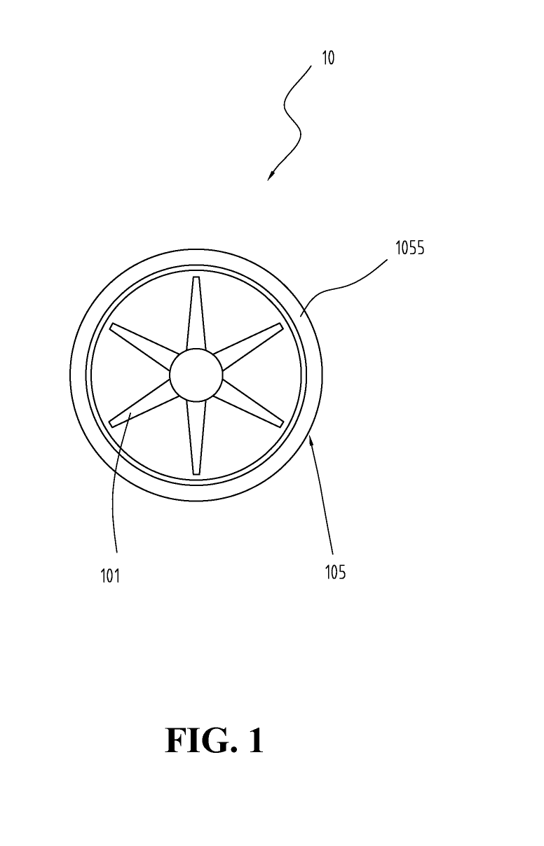

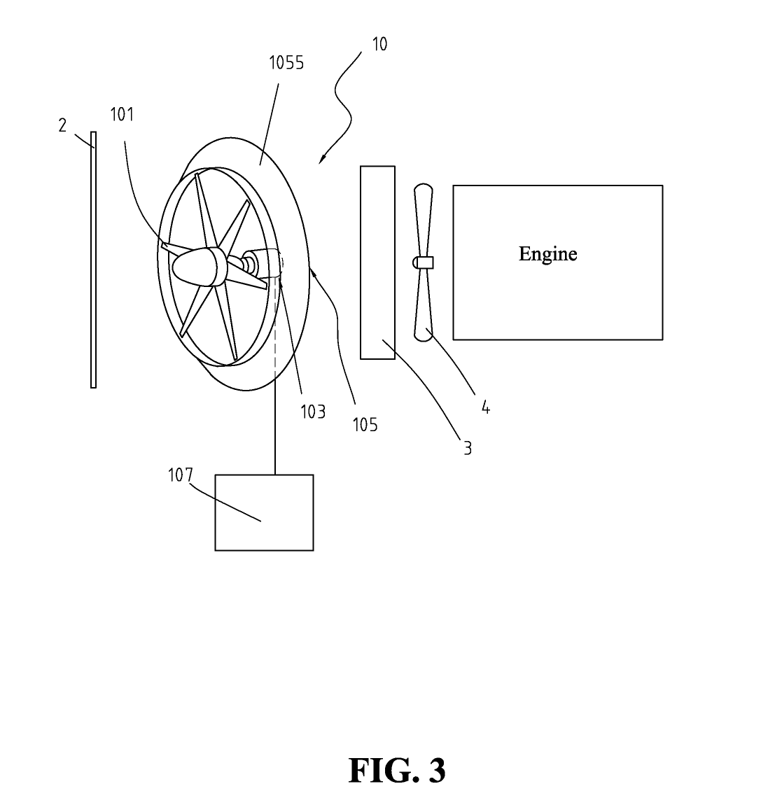

Referring to FIGS. 1, 2, and 3, a wind power generating device 10 for use with a vehicle of the present invention is disposed in the engine chamber of a vehicle. For example, the wind power generating device 10 is disposed between a water tank protective cover 2 and a water tank 3 at the front side of the engine chamber of the vehicle. External air is introduced into the engine chamber of the vehicle in the manner of natural feeding while the vehicle is moving. The air introduced into the engine chamber of the moving vehicle becomes a feeding air current. The feeding air current drives a plurality of fan blades 101 of the wind power generating device 10 to rotate, and thus a rotor of a power generator 103 is driven to rotate. As a result, the power generator 103 generates electric power. According to the present invention, the wind power generating device 10 for use with a vehicle comprises at least one fan blade 101, the power generator 103, and a duct 105, which are described hereunder.

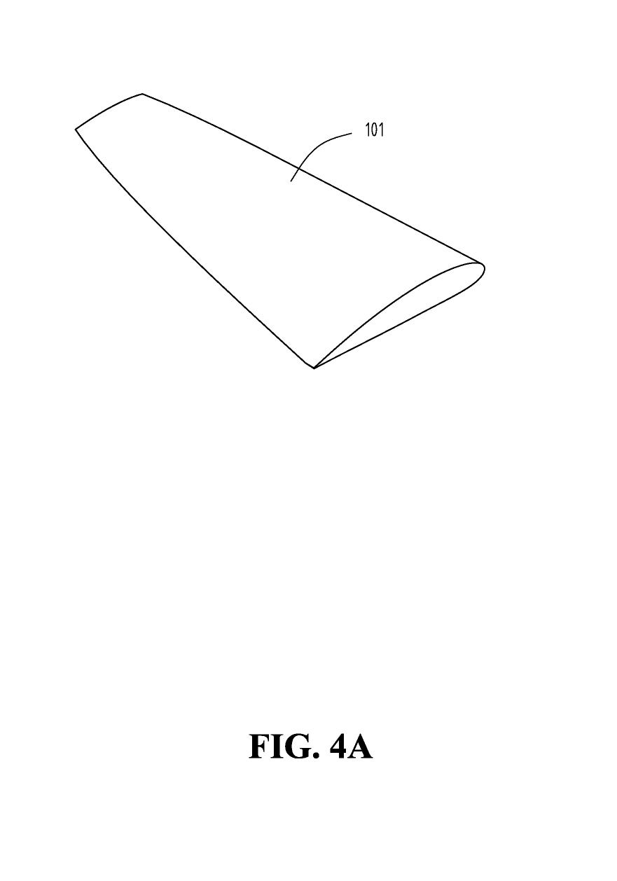

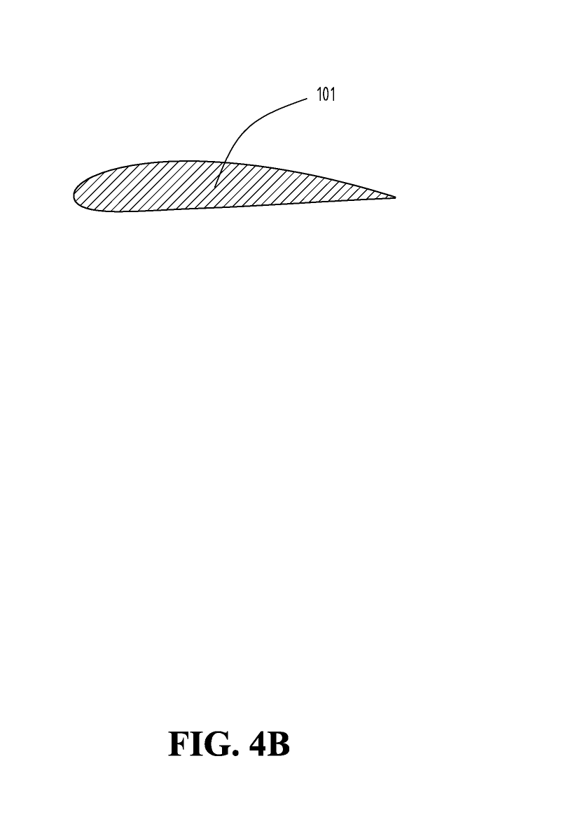

The fan blades 101 rotate when they are driven by the flowing feeding air current. The fan blades 101 are composed of a plurality of said fan blades 101 each having a wing-like cross-section. FIG. 4A illustrates a structure of a fan blade of the wind power generating device for use with a vehicle in an embodiment according to the present invention. FIG. 4B is a cross-sectional view of the fan blade shown in FIG. 4A. It is also feasible for the fan blades 101 to be any other conventional fan blades. The fan blades 101 of the present invention are not limited to the ones shown in FIG. 4A through FIG. 4B; instead, equivalent changes made to the fan blades 101 of the present invention by persons skilled in the art should fall within the scope of the present invention.

The power generator 103 operates in conjunction with the fan blades 101. Once the fan blades 101 start to rotate, the rotation of the fan blades 101 drives the rotor of the power generator 103; as a result, the power generator 103 generates electric power. Means for transmission between the fan blades 101 and the power generator 103 according to the present invention abounds. For example, the axle of the fan blades 101 directly drives the rotor of the power generator 103 located at a rear position. Alternatively, the aforesaid transmission is effectuated by a conveyor belt or a gear train. The rotational movement of the fan blades 101 is transmitted, by the conveyor belt or the gear train, to the power generator 103 located in the vicinity of the fan blades 101. It is feasible for the power generator 103 to be a conventional power generator.

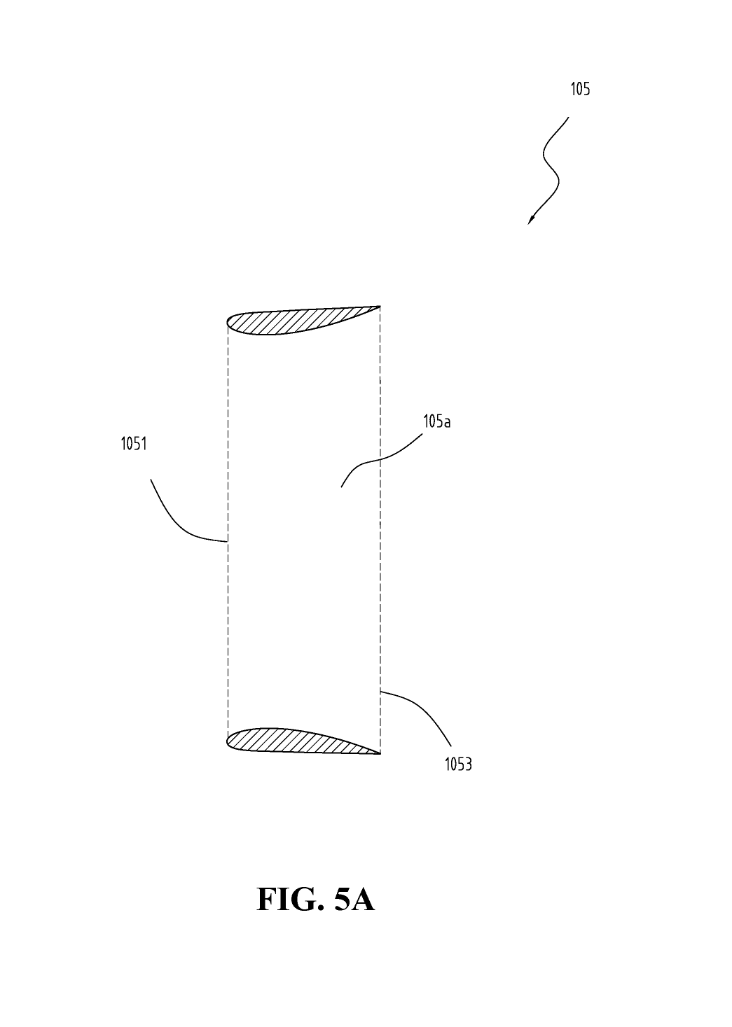

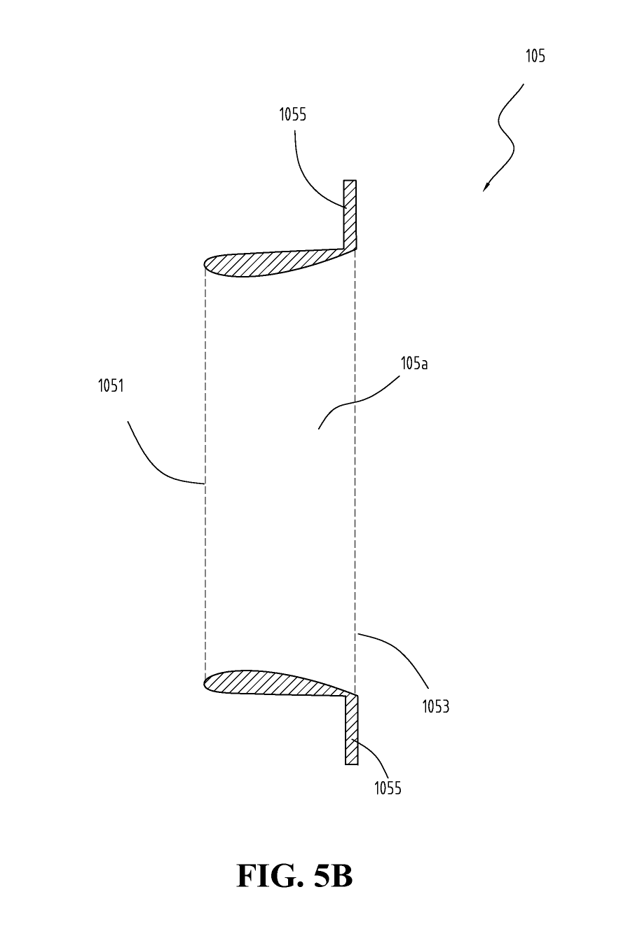

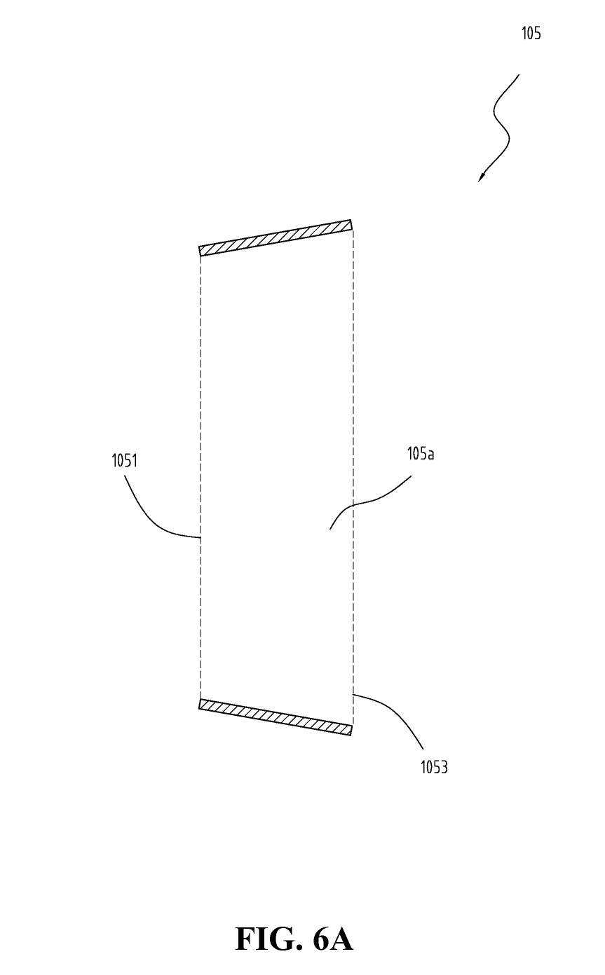

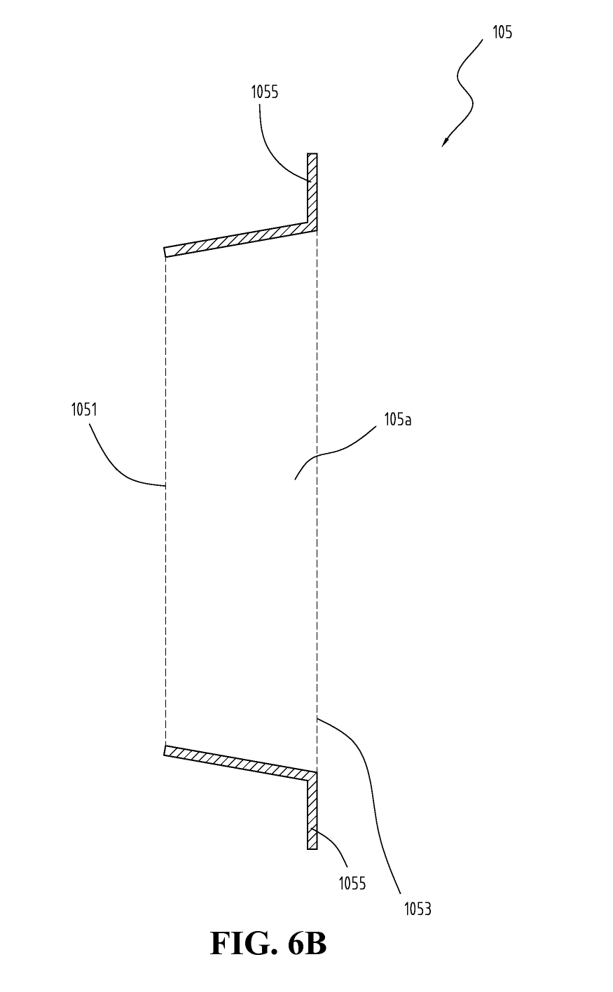

The duct 105 circumferentially encloses the fan blades 101 by being disposed at the rim thereof. The duct 105 has an opening 105a. The fan blades 101 are received in the opening 105a. The duct 105 is spaced apart from the outermost portion of the fan blades 101 by a gap. The fan blades 101 rotate freely within the opening 105a. Referring to FIG. 5A through FIG. 6B, a front opening portion 1051 of the opening 105a functions as an inlet of the aforesaid external air, and a rear opening portion 1053 of the opening 105a functions as an outlet of the aforesaid external air. That is to say, a wind-incoming plane of the fan blades 101 is provided by the front opening portion 1051, and a wind-outgoing plane of the fan blades 101 is provided by the rear opening portion 1053. It shall be noted that the front opening portion 1051 is smaller than the rear opening portion 1053. It is feasible that the duct 105, for example, has a hollow core.

With the front opening portion 1051 being smaller than the rear opening portion 1053, the air current moves into the front opening portion 1051 and out of the rear opening portion 1053 fast to thereby enhance the rotational efficiency of the fan blades 101, and further increase the power generation capacity of the power generator 103.

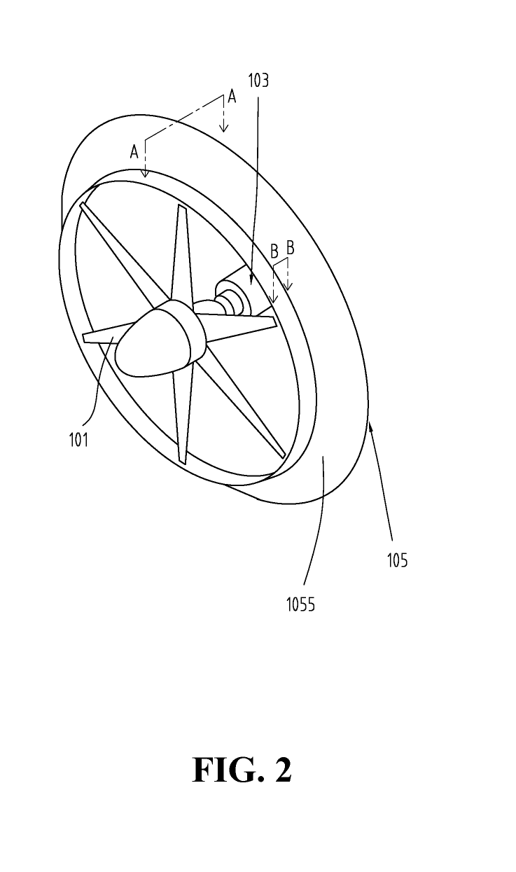

FIG. 5A is a cross-sectional view of a duct taken along line B-B of FIG. 2, wherein the duct is configured to be applied to the wind power generating device for use with a vehicle in an embodiment according to the present invention. FIG. 5B is a cross-sectional view of a protruding portion of the duct 105 shown in FIG. 5A and which is taken along line A-A of FIG. 2. As shown in FIG. 5A, the duct 105 has a wing-like cross-section or arc-shaped cross-section. As shown in FIG. 5B, the external edge of the duct 105 is further provided with a protruding portion 1055. The protruding portion 1055 protrudes outward from the external edge of the duct 105.

FIG. 6A is a cross-sectional view of the duct configured to be applied to the wind power generating device for use with a vehicle in another embodiment according to the present invention. FIG. 6B is a cross-sectional view of the protruding portion of the duct shown in FIG. 6A. It is feasible that the duct 105 has a trapezoidal and hollow core. Furthermore, the external edge of the duct 105 is further provided with the protruding portion 1055. The protruding portion 1055 protrudes outward from the external edge of the duct 105.

The duct 105 of the present invention is not limited by FIG. 5A through FIG. 6B; instead, all equivalent changes made by persons skilled in the art to the duct 105 of the present invention shall fall within the scope of the present invention.

Also, the wind power generating device 10 of the present invention further comprises a rechargeable battery 107. The rechargeable battery 107 is electrically connected to the power generator 103. The function of the rechargeable battery 107 is to store the electric power generated by the power generator 103.

With a wind power generating device of the present invention, a feeding air current introduced into an engine chamber of a vehicle in the manner of natural feeding can function as a wind source of wind power generation, and a duct of the wind power generating device enhances the rotational efficiency of the fan blades to thereby increase the power generation capacity of a power generator, which are attributed to the obvious advantages of the present invention.

Although the present invention is illustrated with the preferred embodiments above, the scope of implementation of the present invention shall not be limited to the above embodiments. Persons skilled in the art shall understand all obvious and equivalent changes and modifications made in the above embodiments of the present invention shall be interpreted as not departing from the substantive contents of the present invention.

What is claimed is:

1. A wind power generating device for use with a vehicle, wherein the wind power generating device being disposed in a front side of an engine chamber of the vehicle, comprising:
at least one fan blade, being driven to rotate by a current of external air, wherein the external air is introduced into the engine chamber by natural feeding while the vehicle is moving;
a power generator for operating in conjunction with the fan blades and generating electric power; and
a duct circumferentially disposed at an outermost portion of the fan blades and having an opening, the opening receiving the fan blades, wherein the opening has a front opening portion functioning as an inlet for the external air and a rear opening portion functioning as an outlet for the external air, and the front opening portion being smaller than the rear opening portion.

2. The wind power generating device of claim 1, wherein the duct further comprises a protruding portion disposed at an external edge of the duct to thereby protrude outward therefrom.

3. The wind power generating device of claim 1, wherein the duct has a cross-section of a shape selected from the group consisting of a wing-like shape, an arc-like shape, and a rectangular shape.

4. The wind power generating device of claim 1, wherein the duct has a hollow core.

5. The wind power generating device of claim 1, wherein the duct is spaced apart from an outermost portion of the fan blades by a gap.

6. The wind power generating device of claim 1, further comprising a rechargeable battery electrically connected to the power generator and configured to store electric power generated by the power generator.
